(19) United States
(12) Patent Application Publication
(10) Pub. No.: US 2007/0031319 A1
(43) Pub. Date: Feb. 8, 2007

(54) Carbon material

(75) Inventors: Thomas Luthge, Hanau (DE); Ralph McIntosh, Hanau (DE); Gerd Tauber, Seligenstadt (DE); Werner Kalbitz, Rodenbach (DE); Stephan Ludtke, Maintal (DE); Egon Fanghanel, Halle/S. (DE); Gerd Schukat, Merseburg (DE)

Correspondence Address: FITCH, EVEN, TABIN & FLANNERY, P. O. BOX 18415, WASHINGTON, DC, 20036, US

(73) Assignee: Degussa AG, Dusseldorf (DE)

(21) Appl. No.: 11/497,316

(22) Filed: Aug. 2, 2006

(30) Foreign Application Priority Data
Aug. 4, 2005 (DE) 102005037336.4

(51) Int. Cl. C01B 31/00

(52) U.S. Cl. 423/447.1; 423/448

(57) ABSTRACT

Carbon material having organic groups, obtainable by the reaction of carbon material with organic compounds of the general formula 1 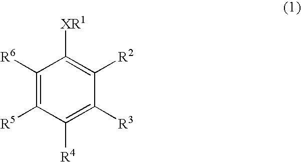 The invention's carbon materials having organic groups are useful in dispersions, rubber, plastics, inks, including solventborne inks, waterborne inks, inkjet inks, xerographic toners, coatings, paints, bitumen, concrete or other building materials, paper or as a reducing agent in metallurgy.

### CROSS REFERENCE TO RELATED APPLICATIONS

The present application claims priority under 35 U.S.C. § 119 to German application 10 2005 037 336.4, filed on Aug. 4, 2005, the contents of which is incorporated by reference in its entirety.

### FIELD OF THE INVENTION

The invention relates to a carbon material, to a process for preparing it and to its use.

### BACKGROUND OF THE INVENTION

EP 0 569 503 discloses a process for surface-modifying carbon material with aromatic groups by electrochemical reduction of a diazonium salt.

It is further known to provide carbon material with organic groups by linking the organic groups to the carbon material via a diazotization/azo coupling (WO 96/18688).

It is further known to provide carbon materials with organic groups by bonding the organic groups to the carbon material by means of reactions with free-radical formers (Ohkita K., Tsubokawa N. and Saitoh E., Carbon 16 (1978) 41; DE 100 12 784.3) or via cycloadditions (DE 100 12 783.5). It is known to react carbon material with aliphatic compounds possessing diazonium groups (JP 11315220 A; Tsubokawa N., Kawatsura K. and Shirai Y., Int. Conf. Mater. Proc. 11 (1997) 537; Tsabukoawa N., Yanadori K. and Sone Y., Nippon Gomu Kyokaishi 63 (1990) 268). The compounds used are aliphatic compounds and not aromatic diazonium salt compounds. Bond formation between the compounds containing diazonium groups and the carbon material takes place through detachment of nitrogen and the formation of free-radical species which can serve as starting functions for further reactions (grafting).

It is likewise known to modify carbon material by reaction with sulphuric acid or SO₃ (U.S. Pat. No. 3,519,452; JP 2001-254033).

JP 20011329205 discloses reacting carbon material in a two-stage reaction first with OH-functionalized cyclopentadienyl compounds and then with sulphuric acid.
Existing processes have the following disadvantages:
The diazotizing agents used, as well as the toxic and oxidizing sodium nitrite, similarly include nonionic organic nitrites, which are toxic and highly flammable. Residues of the nitrites (counter-ions, alkyl radicals) remain in the carbon material as an unattached impurity.
Nitrite has to be used in an acidic medium to carry out the diazotization. Toxic oxides of nitrogen can form.
Free-radical formers are thermally or photochemically labile, explosive and can lead to chain reactions which are difficult to control.
Synthesis and purification of the free-radical formers' precursor in some instances involve toxic or odour-nuisance materials and hence are cost intensive with regard to the manufacturing process, transport, use and final disposal.
Cyclization reactions with nitrogenous heterocycles proceed with nitrogen extrusion, which can lead to sudden, explosive volume expansions or pressure rises which significantly hinder smooth reaction management.
The reaction of carbon material with compounds that possess azo groups and form free radicals by nitrogen extrusion can likewise lead to sudden, explosive volume expansions or pressure rises or else to thermal difficult-to-control chain reactions and thus hinder smooth reaction management.
The reaction of carbon material with sulphuric acid or oleum requires particularly durable, corrosion-resistant and thermally stable materials; unwanted and hazardous oxidations can occur as a secondary reaction; and the neutralization needed after the reaction can generate wastewaters having a high salt content, in which case a portion of the generated salts can remain behind on the carbon material as an impurity, and this can lead to performance disadvantages.
The two-stage reaction with cyclopentadienyls and sulphuric acid likewise has the disadvantage that corrosion-resistant and thermally stable materials are needed. Moreover, by-products, some of them soluble, which can likewise lead to disadvantages, may arise in a both quantitatively and qualitatively sizable amount.

Coloured by-products are also disadvantages of existing carbon materials having organic groups.

### DESCRIPTION OF THE INVENTION

It is an object of the invention to provide a carbon material having organic groups which contains little by way of coloured by-products.

The invention provides a carbon material having organic groups, characterized in that it is obtainable by the reaction of carbon material with organic compounds of the general formula 1, 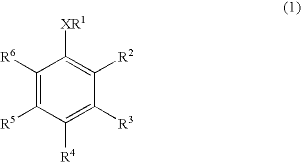
where X is O, S, NR⁷ or PR⁷, and R¹-R⁷ are the same or different and consist of H, acceptor groups, donor groups, alkyl or aryl groups having acceptor and donor groups respectively, hydrophilic and/or hydrophobic groups, or R¹-R⁷ form cyclic systems which are in turn substituted by acceptor or donor groups and/or hydrophilic or hydrophobic groups.

The reaction of the carbon material with the organic compound of the general formula 1 does not proceed via a diazonium salt.

Acceptor groups may be —COOR⁸, —CO—R⁸, —CN, —SO₂R⁸ or —SO₂OR⁸, where R⁸ is metal, H, alkyl, aryl, ammonium or functionalized alkyl or aryl, for example ω-carboxyalkyl, HSO₃—C_{y}H_{z}—, H₂N—C_{y}H_{z}— or H₂N—SO₂—C_{y}H_{z}— (y=1-45, z=1-45). Donor groups may be SR⁹, OR⁹ or N(R⁹)₂, where R⁹ is H, alkyl, aryl or functionalized alkyl or aryl.

Hydrophilic groups may be SO₃M (M=metal), COOM or —(CH₂—CH₂—O)ₙ—R⁹, where n=1-45. Hydrophobic groups may be alkyl, aryl, fluoroalkyl, perfluoroalkyl, fluoroaryl or perfluoroaryl.

The organic groups R¹-R⁹ may be:

substituted or unsubstituted, branched or unbranched,

an aliphatic group, for example radicals from alkanes, alkenes, alcohols, ethers, aldehydes, ketones, carboxylic acids, esters, hydrocarbons, sulphonic acids, amines, trialkylammonium salts, trialkylphosphonium salts or dialkylsulphonium salts,

a cyclic compound, for example alicyclic hydrocarbons, such as for example cycloalkyls or cycloalkenyls, heterocyclic compounds, such as for example pyrrolidinyl, pyrrolinyl, piperidinyl or morpholinyl groups, aryl groups, such as for example phenyl, naphthyl or anthracenyl groups, or heteroaryl groups, such as for example imidazolyl, pyrazolyl, pyridinyl, thienyl, thiazolyl, furyl or indolyl groups,

a heterocyclic compound containing nitrogen or further heteroatoms and forming a three-, four-, five-, six- or more highly membered ring which in turn is substituted by H, alkyl or aryl groups having acceptor or donor substituents or parts of cyclic systems having acceptor or donor substituents and/or hydrophilic or hydrophobic groups,

substituted by further functional groups,

a chromophoric group or a dye or

suitable reactive compounds, such as for example triarylammonium, triarylphosphonium, diarylsulphonium and aryliodinium salts.

The group of the organic compounds of the general formula 1 may be tailored to the potential fields of use, since the reaction principle permits for example not only the introduction of hydrophilic but also the introduction of lipophilic groups. The groups may also be ionic, polymeric or further reactive. The groups may be used to modify different, technically interesting properties of the carbon material in a specific manner. For instance, the hydrophilicity of the carbon material can be raised to such an extent that the carbon material forms stable dispersions in aqueous media without use of a wetting agent.

Compounds of the general formula 1 may be for example compounds of the general formula 2 or 3: 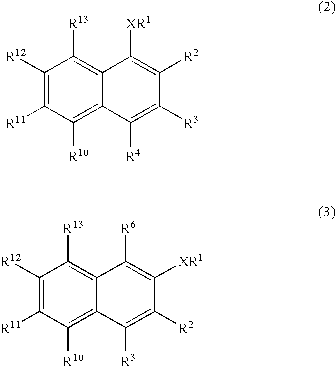
where R¹-R⁴ are each as defined above and R¹⁰-R¹³ are the same or different and consist of H, acceptor groups, donor groups, alkyl or aryl groups having acceptor or donor groups, hydrophilic and/or hydrophobic groups or R¹⁰-R¹³ form cyclic systems which in turn are substituted by acceptor or donor groups and/or hydrophilic or hydrophobic groups.

The compounds of the general formula 1 may be for example:

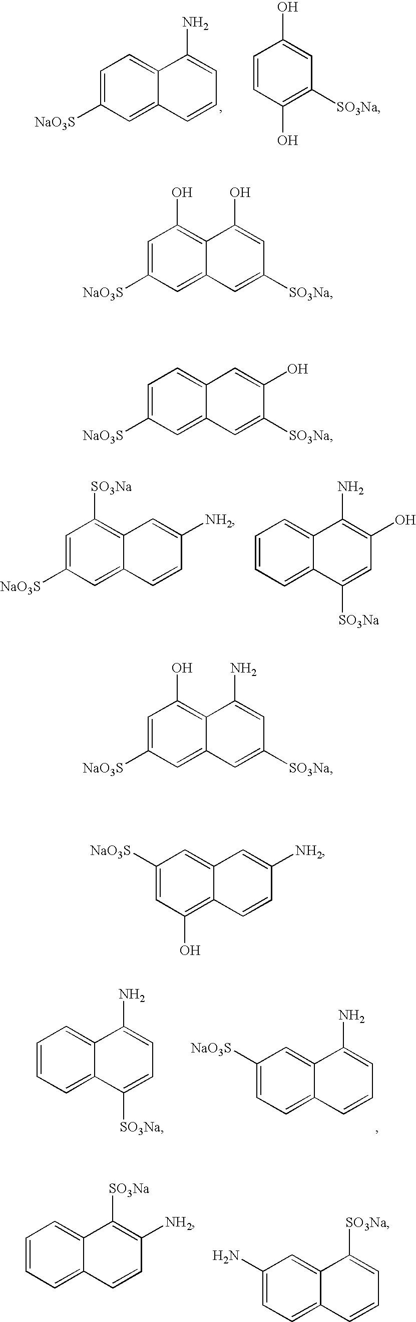

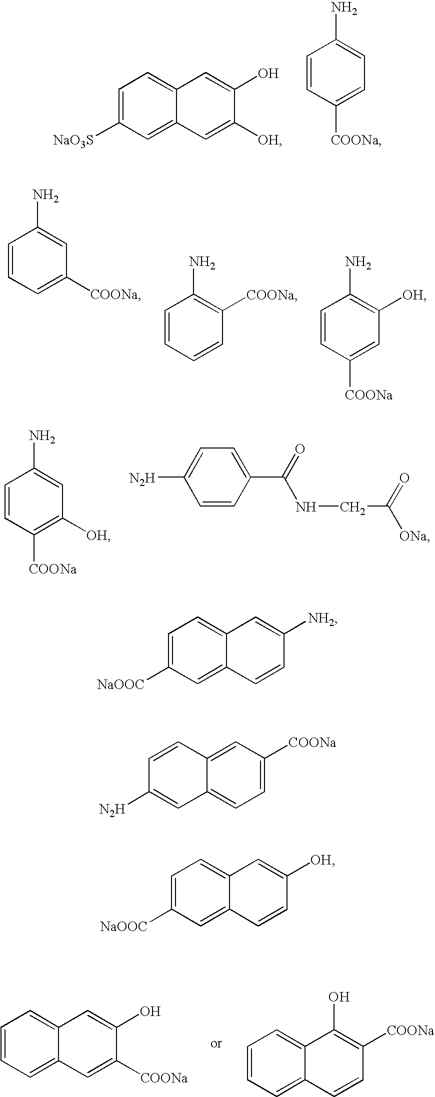

The abovementioned compounds can be used in the depicted salt form or with some other counter-ion, for example K or N(R⁹)₄.

Useful carbon material includes carbon black, graphite powder, graphite fibres, carbon fibres, carbon fibrils, carbon nanotubes, carbon fabrics, glassy carbon products, activated carbon or fullerenes.

Useful carbon black includes furnace black, gas black, channel black, lamp black, thermal black, acetylene black, plasma black, inversion black, known from DE 195 21 565, Si-containing blacks, known from WO 98/45361 or DE 196 13 796, or metal-containing carbon blacks, known from WO 98/42778, arc carbon and soots which are by-products of chemical manufacturing operations.

The invention's carbon material having organic groups and/or the carbon material can be activated by means of upstream reactions. These can be oxidation reactions for example. Useful oxidizing agents include for example ammonium peroxodisulphate, hydrogen peroxide, ozone, oxygen (pure or as air), potassium bromide and/or sodium perborate.

Carbon materials used as a reinforcing filler in rubber mixtures can be used. Pigment grade carbon blacks can be used. Useful carbon materials further include: conductivity black, carbon material for UV stabilization, carbon material useful as a filler and in systems other than rubber, such as for example in bitumen or plastics, or carbon material useful as a reducing agent in metallurgy.

The present invention further provides a process for preparing the invention's carbon material having organic groups, the process being characterized in that carbon material is reacted with organic compounds of the general formula 1.

The reaction of the carbon material with the organic compound of the general formula 1 does not proceed via a diazonium salt; that is, no diazonium salt is used or formed during the reaction.

The organic compound of the general formula 1 can be applied to the carbon material by spray-drying a dispersion comprising the carbon material and compound of the general formula 1, mixing or spraying. The organic compound of the general formula 1 may be applied as a powder, as a melt or as a solution. It may be particularly advantageous to apply the organic compound of the general formula 1 during the preparation of the carbon material, in which case the organic compound of the general formula 1 is preferably added at a position in the reactor that has the necessary temperature. The reaction for modifying the carbon material may preferably be carried out in the absence of a solvent or else in a solvent, preferably a volatile organic solvent. The reaction for modifying the carbon material may be carried out at temperatures from −80° C. to +300° C., preferably from 80° C. to 250° C. When the modifying takes place during the production of the carbon material, the temperatures may be between 250° C. and 1500° C. The energy input may be effected by means of mechanical energy, vibrational energy, for example ultrasound, or irradiational energy, for example microwave radiation, heat radiation, light radiation, X-rays and electron beam radiation. The reaction for modifying the carbon material may be carried out in the absence of an oxidizing agent or in the presence of an oxidizing agent (for example air, hydrogen peroxide, peroxides, perborates, persulphates or ozone).

The reaction of carbon material with compounds of the general formula 1 can be carried out in a ratio of carbon material to compound of the general formula 1 in the range from 99.99:0.01 to 0.01:99.9. The ratio of carbon material to compound of the general formula 1 may preferably be in the range from 50:1 to 1:50.

The reaction of carbon material with compounds of the general formula 1 can be carried out in the pressure range from 1 mbar to 250 bar. The reaction may preferably take place in the pressure range 100 mbar to 50 bar.

The invention's carbon materials having organic groups can be used as a filler, including as a reinforcing filler, a UV stabilizer, as a conductivity carbon black or as a pigment. The invention's carbon materials having organic groups can be used in rubber, plastics, inks, including solventborne inks, waterborne inks, inkjet inks, xerographic toners, coatings and paints, bitumen, concrete or other building materials or paper. The invention's carbon materials can further be used as a reducing agent in metallurgy. The invention's carbon materials having organic groups can be used for producing rubber mixtures, in particular for producing tyres.

The invention further provides a dispersion characterized in that it comprises the invention's carbon material having organic groups and at least one solvent.

The organic group may be tailored to the particular dispersion medium. Carbon materials modified with polar organic groups may be particularly useful for polar media. Polar media may be solvents, for example alcohols, ketones, esters, acids, amines, glycols, glycol ethers or halogenated solvents, but also oligomers or polymers having polar groups, for example carbonyl, ester, amino, carboxyl and/or hydroxyl groups. Carbon materials having organic groups, for example —SO₃W, COOW or OH, where W is H, alkali metal ions or ammonium ions, can be particularly useful for aqueous media. Hydrophobic modified carbon materials having hydrophobic groups, such as alkyl, alkyloxy, aryl and/or hetaryl, can be particularly useful for hydrophobic media such as aliphatic, aromatic, heteroaliphatic and/or heteroaromatic hydrocarbons. Media which in terms of their polarity are between the relatively apolar, hydrophobic media and the strongly polar media, for example ethers and/or mixtures of polar and apolar media, may be particularly suitably served by specifically adapted modifications, for example with amino, carbonyl or halogen substituents.

The dispersion of the present invention may further comprise one or more additives, such as biocides, wetting agents, ketones, glycols, alcohols or mixtures thereof. These additives may be added for specific applications and may also consist of monomeric, oligomeric or polymeric compounds for example. These additives may effect improvements in properties, such as degree of dispersion, storage stability, freeze stability, drying behaviour, foaming ability, wettability and/or bonding to certain substrate materials, such as paper, metal, glass, polymers, fibres, leather, wood, concrete or rubber.

The present invention further provides a process for producing the dispersion of the invention, the process being characterized in that the invention's carbon material having organic groups is dispersed in at least one solvent using a bead mill, an ultrasonicator, a high pressure homogenizer, a microfluidizer, a rotor-stator assembly, for example Ultra-Turrax, or a comparable assembly.

The dispersions of the present invention can be used in rubber, plastics, inks, including solventborne inks, waterborne inks, inkjet inks, xerographic toners, coatings and paints, bitumen, concrete and other building materials or paper.

The dispersions of the present invention can be used for coloration and for UV stabilization of plastics, latices, textiles, leather, adhesives, silicones, concrete, building materials, paper, fibres and earth or for antistatic rendering of materials.

The invention's carbon materials having organic groups have the advantage that:

polar modified carbon materials (having SO₃M substituents for example) are better dispersible in polar systems, primarily water,

apolar modified carbon materials (having alkyl groups for example) are better dispersible in apolar systems, for example oils,

suitably modified carbon materials having polar or sterically bulky groups are stabilized electrostatically and sterically, respectively, in the systems and require no further auxiliaries, say wetting agents, for stabilization,

carbon materials modified by the process of the present invention are better stabilized in dispersions and so have better colour properties, such as depth of shade and bluishness,

carbon materials modified by the process of the present invention are by virtue of the broader variability of the hydrophilic substituents better tailorable to specific performance requirements (for example high optical density and low intercolour bleeding in inkjet),

carbon materials having bound dyes have modified hues,

carbon materials having still reactive substituents can be utilized for coupling and crosslinking in systems (rubber for example),

reactive modified carbon materials allow bonding of the carbon materials to a polymer, and

carbon materials are producible that are low in by-products, salts, acids and moisture.

### EXAMPLES

The examples utilize Ruβ S 160 black carbon. Ruβ S 160 is a commercial product of Degussa AG.

Determination of pH:

pH is determined using a Schott CG 837 pH meter on the neat suspension. The glass electrode is dipped into the solution and the temperature-corrected pH is read off five minutes later.

Determination of Viscosity:

The rheology of the neat suspension is determined using a Physica UDS 200 rheometer in a rotation test at controlled rate of shear (CRS). The sample is temperature controlled to 23° C. The viscosity value is read off at a shear rate of 1000 S⁻¹.

Determination of Surface Tension:

Dynamic and static surface tension of a temperature controlled sample at 20° C. is determined using a Krüss BP2 bubble tensiometer. The final value is read off at 15 ms for dynamic surface tension and at 3000 ms for static surface tension.

### Example 1

### Modification of Carbon Material with Sodium 7-amino-4-hydroxy-2-naphthalenesulphonate

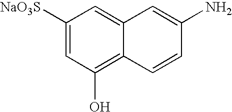

4 g of 7-amino-4-hydroxy-2-naphthalenesulphonic acid are suspended in 150 ml of water and made to dissolve by stirring with 0.67 g of sodium hydroxide in 50 ml of water, 20 g of Ruβ S 160 carbon black are added, then the solvent is distilled off under reduced pressure and the remaining mixture is heated to 180° C. for 4 hours.

### Example 2

### Modification of Carbon Material in Solid Phase With sodium 5-amino-2-naphthalenesulphonate

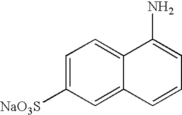

4 g of sodium 5-amino-2-naphthalenesulphonate and 20 g of Ruβ S 160 carbon black are mixed, 5 ml of water are added dropwise, everything is mixed once more and the mixture is then heated to 180° C. for 4 hours.

### Example 3

### Modification of Carbon Material with Sodium 5-amino-2-naphthalenesulphonate

4 g of sodium 5-amino-2-naphthalenesulphonate are suspended in 150 ml of water and made to dissolve by stirring with 0.72 g of sodium hydroxide in 50 ml of water, 20 g of Ruβ S 160 are added, then the solvent is distilled off under reduced pressure and the remaining mixture is heated to 180° C. for 4 hours.

### Example 4

### Modification of Carbon Material with Sodium Hydroquinonesulphonate

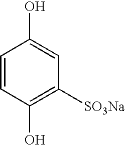

4 g of sodium hydroquinonesulphonate and 4.5 g of ammonium peroxodisulphate are each dissolved in 150 ml of water and added in succession to 20 g of Ruβ S 160 carbon black, then the solvent is distilled off under reduced pressure and the remaining mixture is heated to 180° C. for 4 hours. The modified carbon black is washed with 300 ml of water and then dried at room temperature.

### Example 5

### Modification of Carbon Material with Disodium 4,5-dihydroxy-2,7-naphthalenedisulphonate

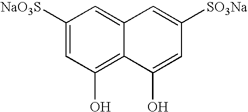

4 g of disodium 4,5-dihydroxy-2,7-naphthalenesulphonate are dissolved in 200 ml of water and added to 20 g of Ruβ S 160 carbon black. Then, 10 ml of 30 percent hydrogen peroxide are added and the solvent is distilled off under reduced pressure. The remaining mixture is heated to 180° C. for 4 hours. The modified carbon black is washed with 300 ml of water and then dried at room temperature.

### Example 6

### Modification of Carbon Material in Solid Phase With sodium 4-amino-3-hydroxynaphthalenesulphonate

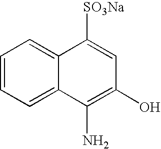

4 g of sodium 4-amino-3-hydroxynaphthalenesulphonate and 20 g of Ruβ S 160 carbon black are mixed, 3 ml of 30 percent hydrogen peroxide are added dropwise, everything is mixed once more and the mixture is subsequently heated to 180° C. for 4 hours. The modified carbon black is washed with 300 ml of water and then dried at room temperature.

### Example 7

### Modification of Carbon Material with Disodium 4-amino-5-hydroxy-2,7-naphthalenedisulphonate

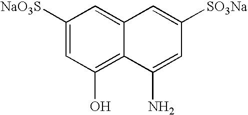

4 g of disodium 4-amino-5-hydroxy-2,7-naphthalenedisulphonate were dissolved in 250 ml of water and added to 20 g of Ruβ S 160 carbon black and then the solvent is distilled off under reduced pressure. The residue and 2.7 g of ammonium peroxodisulphate are mixed and subsequently heated to 180° C. for 4 hours. The modified carbon black is washed with 300 ml of water and then dried at room temperature.

### Example 8

### Modification of Carbon Material with Sodium 6-amino-2-naphtholcarboxylate

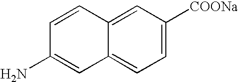

4 g of 6-amino-2-naphtholcarboxylic acid are suspended in 200 ml of water, neutralized to pH 7.5 and dissolved by stirring with 1 mol/l NaOH solution. 40 g of Ruβ S 160 carbon black are added, then the solvent is distilled off under reduced pressure and the remaining mixture is heated at 200° C. for 4 hours.

### Example 9

### Dispersion of Modified Carbon Material in Water

15 g of carbon material having organic groups according to Example 1 are stirred with 85 ml of water and subsequently dispersed using an Ultra-Turrax at 5000 rpm for 30 minutes. The dispersion obtained is stable without further addition of wetting agent.

Dynamic surface tension at 15 ms: 78 mN/m

Static surface tension at 3000 ms: 69 Nm/m

pH: 6.5

Viscosity: 3.2 mPas

### Example 10

### Dispersion of Modified Carbon Material in Water

15 g of carbon material having organic groups according to Example 2 are stirred with 85 ml of water and subsequently dispersed using an Ultra-Turrax at 5000 rpm for 30 minutes. The dispersion obtained is stable without further addition of wetting agent.

Dynamic surface tension at 15 ms: 82 mN/m

Static surface tension at 3000 ms: 71 Nm/m

pH: 7.2

Viscosity: 2.9 mPas

### Example 11

### Dispersion of Modified Carbon Material in Water

15 g of carbon material having organic groups according to Example 3 are stirred with 85 ml of water and subsequently dispersed using an Ultra-Turrax at 5000 rpm for 30 minutes. The dispersion obtained is stable without further addition of wetting agent.

Dynamic surface tension at 15 ms: 77 mN/m

Static surface tension at 3000 ms: 70 Nm/m

pH: 7.0

Viscosity: 2.7 mPas

### Example 12

### Dispersion of Modified Carbon Material in Water

15 g of carbon material having organic groups according to Example 4 are stirred with 85 ml of water and subsequently dispersed using an Ultra-Turrax at 5000 rpm for 30 minutes. The dispersion obtained is stable without further addition of wetting agent.

Dynamic surface tension at 15 ms: 81 mN/m

Static surface tension at 3000 ms: 70 Nm/m

pH: 7.5

Viscosity: 2.9 mPas

### Example 13

### Dispersion of Modified Carbon Material in Water

15 g of carbon material having organic groups according to Example 8 are stirred with 85 ml of water and subsequently dispersed using an Ultra-Turrax at 5000 rpm for 30 minutes. The dispersion obtained is stable without further addition of wetting agent.

Dynamic surface tension at 15 ms: 86 mN/m

Static surface tension at 3000 ms: 71 Nm/m

pH: 8.5

Viscosity: 2.7 mPas

1-13. (canceled)

14. A process for producing carbon material with organic groups, comprising reacting carbon material with organic compounds of formula 1: 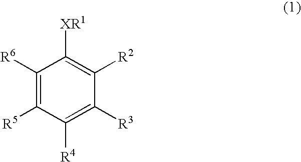
where X is O, S, NR⁷ or PR⁷, and
R¹-R⁷ are the same or different and are selected from the group consisting of: H; acceptor groups; donor groups; alkyl or aryl groups having acceptor and donor groups respectively; hydrophilic and/or hydrophobic groups; or R¹-R⁷ form cyclic systems which are optionally substituted by acceptor or donor groups and/or hydrophilic or hydrophobic groups.

15. The process of claim 14, wherein said carbon material is selected from the group consisting of: carbon black; graphite powder; graphite fibres; carbon fibres; carbon fibrils; carbon nanotubes; carbon fabrics; glassy carbon products; activated carbon; and fullerenes.

16. The process of claim 14, wherein said acceptor groups are —COOR⁸, —CO—R⁸, —CN, —SO₂R⁸ or —SO₂OR⁸, wherein R⁸ is a metal, H, alkyl, aryl, ammonium or a functionalized alkyl or aryl.

17. The process of claim 14, wherein said donor groups are SR⁹, OR⁹ or N(R⁹)₂, wherein R⁹ is H, alkyl, aryl or a functionalized alkyl or aryl.

18. The process of claim 14, wherein said hydrophilic groups are SO₃M, COOM or —CH₂—CH₂—O)ₙ—R⁹, wherein M is a metal, n is 1-45, and said hydrophobic groups are alkyl, aryl, fluoroalkyl, perfluoroalkyl, fluoroaryl or perfluoroaryl.

19. The process of claim 14, wherein:
a) said carbon material is selected from the group consisting of: carbon black; graphite powder; graphite fibres; carbon fibres; carbon fibrils;
carbon nanotubes; carbon fabrics; glassy carbon products; activated carbon; and fullerenes;
b) said acceptor groups are —COOR8, —CO—R⁸, —CN, —SO₂R⁸ or —SO₂OR⁸, where R⁵ is a metal, H, alkyl, aryl, ammonium or a functionalized alkyl or aryl;
c) said donor groups are SR⁹, OR⁹ or N(R⁹)₂, where R⁹ is H, alkyl, aryl or a functionalized alkyl or aryl;
d) said hydrophilic groups are SO₃M, COOM or —CH₂—CH₂—O)ₙ—R⁹, wherein M is a metal and n is 1-45; and
e) said hydrophobic groups are alkyl, aryl, fluoroalkyl, perfluoroalkyl, fluoroaryl or perfluoroaryl.

20. A carbon material with organic groups, made by the process of claim 14.

21. The carbon material with organic groups of claim 20, having the structure of either formula 2 or 3: 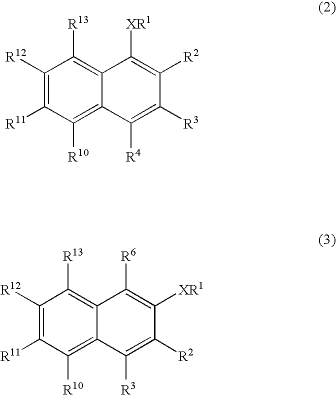
wherein R¹-R⁶ are each as defined in claim 14 and R¹⁰-R¹³ are the same or different and are selected from the group consisting of: H, acceptor groups, donor groups, alkyl or aryl groups having acceptor or donor groups, hydrophilic and/or hydrophobic groups or R¹⁰-R¹³ form cyclic systems which in turn are substituted by acceptor or donor groups and/or hydrophilic or hydrophobic groups.

22. A product composition comprising the carbon material with organic groups of claim 20, wherein said product composition is selected from the group consisting of: rubber, plastic, ink, xerographic toner, coating, paint, bitumen, concrete or other building material, paper or a composition that serves as a reducing agent in metallurgy.

23. The product composition of claim 22, wherein said product composition is selected from the group consisting of: solvent-borne inks, water-borne inks, and inkjet inks.

24. A dispersion comprising said carbon material with organic groups of claim 20 and at least one solvent.

25. The dispersion of claim 24, further comprising at least one additive.

26. A composition of rubber, plastic, ink, xerographic toner, coating or paint, building material, paper, lattice, textile, leather, adhesive, silicone, fibre or earth, comprising the dispersion of claim 24.

27. The composition of claim 26, wherein said composition is a building material selected from: bitumen and concrete.

28. The composition of claim 26, wherein said composition is a solvent-borne ink, water-borne ink, or inkjet ink.

29. The composition of claim 26, wherein said composition is a plastic, textile, leather, adhesive or silicone.

30. A process for producing the dispersion of claim 24, comprising dispersing the carbon material having organic groups in said solvent using a bead mill, an ultrasonicator, a high pressure homogenizer, a microfluidizer, a rotor-stator assembly or a comparable assembly.
